(19) United States
(12) Patent Application Publication
(10) Pub. No.: US 2019/0122265 A1
(43) Pub. Date: Apr. 25, 2019

(54) Method and system for providing advertisement through lock screen on basis of message associated application

(71) Applicant: Buzzvil Co., Ltd., Seoul (KR)

(72) Inventors: Young Ho LEE, Seoul (KR); Gwan Woo LEE, Seoul (KR)

(21) Appl. No.: 16/091,927

(22) PCT Filed: Apr. 15, 2016
(86) PCT No.: PCT/KR2016/003955

§ 371 Date: Oct. 5, 2018

(30) Foreign Application Priority Data
Apr. 8, 2016 (KR) 10-2016-0043563

(51) Int. Cl. G06Q 30/02

(52) U.S. Cl. CPC G06Q 30/0267; G06Q 30/0239; G06Q 30/0255

(57) ABSTRACT

Provided are a system and a method for providing a message-based application interlocking screen advertisement, which collect advertisement information about an application corresponding to link information linked to an advertisement-related push message received by a user apparatus to generate advertisement contents for a lock screen and then provide the generated advertisement contents to the user apparatus to display the corresponding advertisement contents through the lock screen.

### CROSS-REFERENCE TO RELATED APPLICATIONS

This application is based on and claims the benefit of priority to Korean Patent Application No. 10-2016-0043563 filed on Apr. 8, 2016, with the Korean Intellectual Property Office, the disclosure of which is incorporated herein by reference.

### FIELD OF THE INVENTION

The present invention relates to a system and a method for providing a message-based application interlocking lock screen advertisement and more particularly, to a system and a method for providing a message-based application interlocking lock screen advertisement which collects advertisement information about an application corresponding to link information linked to an advertisement-related push message received by a user apparatus to generate advertisement contents for a lock screen and then provides the generated advertisement contents to the user apparatus to display the corresponding advertisement contents through the lock screen.

### BACKGROUND ART

With the development of a mobile communication technology, as the spread of smart phones becomes more active, various advertisement methods utilizing the smart phones are emerging.

For example, an advertisement server for providing the advertisement links a URL address of the advertisement object to an SMS message to transmit the URL address to a user's smart phone so that the user may access a web page of the advertisement object based on the URL address linked to the SMS message.

Further, the advertisement server generates a push message linked with the URL address for the advertisement object and including unique identification information about an application according to an advertiser's request to transmit the push message to the user's smart phone. Accordingly, when the user accesses the landing page for the advertisement object through the URL address linked with the corresponding push message or selects the push message, an application corresponding to the unique identification information about the application is activated in the user's smart phone so that information on the advertisement object is provided through the corresponding application.

As described above, most of conventional advertisement methods are a method of providing an advertisement by transmitting an SMS or a push-type message to the user, and these conventional advertisement methods have the following problems.

First, since the conventional advertisement method has inconvenience that the user needs to check the entire contents of the message by selecting the corresponding message, most of the users often select and delete the received message without checking the message, and thus there is a problem that an advertisement effect is significantly deteriorated.

In addition, when a message is received on the smart phone of the user, only a part of the message content is displayed on the screen of the user, so that it is difficult for the user to recognize the entire contents at once and also it is difficult to concentrate the attention of the user. Accordingly, even though the message is a message for an interesting object of the user, there is a problem that it is difficult to guide the reading of the message.

In addition, when the advertiser intends to insert the advertisement contents into the message in order to induce the interest of the user related to the advertisement object, there is an inconvenience that the advertiser asks to directly create separate advertisement contents for each of different advertisement objects and then insert the advertisement contents into the message to transmit the message.

Therefore, by improving the existing problems, the development of an effective advertisement method has been required to induce an application related with the advertisement object to be executed while providing the advertisement content to be conveniently checked by the user without a separate input, thereby enhancing the advertisement efficiency and reducing a load on creation of contents of the advertiser.

### PRIOR ART DOCUMENT

### Patent Document

Korean Patent Registration No. 10-1122214

### DISCLOSURE

### Technical Problem

An object of the present invention is to enhance an advertisement effect by concentrating the interest of the user for the advertisement content without generating separate advertisement information of an advertiser by generating advertisement contents for an application corresponding to response information based on the response information received from a user apparatus in correspondence with a push message to provide the generated advertisement contents to the user apparatus and displaying the advertisement contents on the lock screen of the user apparatus, so that a user checks the content of a push message through a lock screen having high attention and a large size.

Another object of the present invention is to enhance an advertisement effect while improving convenience of a user for advertisement browsing by automatically executing a command related with an advertisement object in an application corresponding to a push message at the time of releasing the lock screen based on link information included in the advertisement contents displayed on the lock screen of the user apparatus.

Yet another object of the present invention is to reduce a load on the creation of the advertisement contents of the advertiser requesting the advertisement based on the message and enable double advertisement using the lock screen.

### Technical Solution

An exemplary embodiment of the present invention provides a system for providing a message-based application interlocking lock screen advertisement including a user apparatus and an advertisement service server connected to the user apparatus through a communication network, the system comprising: an advertisement module installed in the user apparatus configured to parse a push message received from the user apparatus, extract at least one of link information and a package ID related with application included in the push message, generate a response information, transmit the generated response information to the advertisement service server, and display lock screen contents received from the advertisement service server in correspondence with the response information; and the advertisement service server configured to access an external server providing the application according to the response information received from the user apparatus, collect advertisement information associated with a predetermined content format in correspondence with the lock screen according to a locked state of the user apparatus from application information corresponding to the link information or the package ID included in the response information, generate the lock screen contents by applying the advertisement information to the content format, and transmit the lock screen contents to the advertisement module of the user apparatus.

In one embodiment related to the present invention, the advertisement information may be a representative image included in the application information.

In one embodiment related to the present invention, the advertisement module may add content information included in the push message to the lock screen contents and display the content information on the lock screen.

In one embodiment related to the present invention, the advertisement module may change at least one of a size and a font of a text included in the content information according to preset setting information to add the changed size or font to the lock screen contents, or collect, when an access address is included in a predetermined filed in attribute information of the push message, advertisement object information corresponding to the access address after accessing the access address to add the collected advertisement object information to the lock screen contents.

In one embodiment related to the present invention, the advertisement object information may be coupon information including a QR code, a barcode, or a coupon or an image for the advertisement object.

In one embodiment related to the present invention, the advertisement module may transmit the content information included in the push message and identification information of the user apparatus to the advertisement service server, and the advertisement service server may transmit request information for requesting user-related private information corresponding to the content information and the identification information to an advertiser server which transmits the push message to the user apparatus, and add the private information received from the advertiser server to the lock screen contents.

In one embodiment related to the present invention, the private information may include at least one of information related to a product to be provided to the user, shopping cart information of the user, and point information of the user.

In one embodiment related to the present invention, the advertisement module may add the link information of the push message to the lock screen contents to display the added link information on the lock screen of the user apparatus and execute, when the locked state according to the lock screen is released in a predetermined direction according to the user input through the user apparatus, the application according to the link information.

In one embodiment related to the present invention, the advertisement module, according to the link information, may execute the application to allow a reward to be paid or change a mode of the application.

In one embodiment related to the present invention, the advertisement service server may preset a plurality of different content formats and apply the advertisement information to the content format corresponding to the response information received from the user apparatus to generate the lock screen contents.

In one embodiment related to the present invention, the advertisement module may be configured by an SDK inserted to the application installed in the user apparatus.

Another exemplary embodiment of the present invention provides a method for providing a message-based application interlocking lock screen advertisement comprising: a response step of receiving, by an advertisement module installed in an user apparatus, a push message related with an application, extracting at least one of link information and a package ID related with application from the push message to generate response information, and transmitting the response information to an advertisement service server through a communication network; a content generation step of accessing, by the advertisement service server, an external server providing the application according to the response information to collect advertisement information associated with a predetermined content format in correspondence with the lock screen according to the locked state of the user apparatus from application information corresponding to the response information, and generating lock screen contents by applying the advertisement information to the content format; a transmission step of transmitting, by the advertisement service server, the lock screen contents to the advertisement module of the user apparatus; and a display step of adding, by the advertisement module, link information of the push message to the generated lock screen contents and displaying the lock screen contents on the lock screen of the user apparatus.

In one embodiment related to the present invention, the advertisement information may be a representative image included in the application information.

In one embodiment related to the present invention, in the display step, the advertisement module may add content information included in the push message to the lock screen contents and display the content information on the lock screen.

In one embodiment related to the present invention, in the display step, according to preset setting information, the advertisement module may change a size and a font of a text included in the content information to add the changed size or font to the lock screen contents, or collect, when an access address is included in a predetermined field in attribute information of the push message, advertisement object information corresponding to the access address after accessing the access address to add the collected advertisement object information to the lock screen contents.

In one embodiment related to the present invention, the advertisement object information may be coupon information including a QR code, a barcode, or a coupon or an image for the advertisement object.

In one embodiment related to the present invention, the method may further include after the display step, an execution step of executing, by the advertisement module, when the locked state according to the lock screen is released in a predetermined direction according to the user input through the user apparatus, the application according to the link information.

In one embodiment related to the present invention, in the execution step, according to the link information, the advertisement module may execute the application to allow a reward to be paid or change a mode of the application.

In one embodiment related to the present invention, in content generation step, the advertisement service server, in which a plurality of different content formats is preset, may apply the advertisement information to the content format corresponding to the response information received from the user apparatus to generate the lock screen contents.

In one embodiment related to the present invention, the advertisement module may be configured by an SDK inserted to the application installed in the user apparatus.

### Advantageous Effects

According to the present invention, the user apparatus transmits a response information to an advertisement service server in correspondence with an application-related push message received from the advertisement service server, and adds an advertisement content and link information of the push message to advertisement contents related with the application provided from the advertisement service server to output the added advertisement content and link information on the lock screen of the user apparatus. As a result, the advertisement content and the advertisement object are provided to be checked on a lock screen having high attention and displayed whenever the user apparatus is activated without executing a separate application for checking the message, thereby greatly enhancing advertisement efficiency by enhancing an exposure frequency of the advertisement for the user through lock screen while concentrating the interest of the user.

Further, an execution command related with an advertisement object is automatically executed by executing a specific application linked to advertisement contents displayed on the lock screen only by a simple input for the release of the lock screen to induce the user to check the advertisement object, thereby enhancing the utilization rate and the advertisement efficiency for the application providing the advertisement object.

Further, according to the present invention, the advertisement contents related with the application of the advertiser is automatically generated based on the message provided from the advertiser and the application information stored in the server in correspondence with the advertiser without requesting separate creation of advertisement contents for transmission to the user apparatus to the advertiser for advertising the application to be displayed on the lock screen of the user apparatus, thereby greatly enhancing convenience of advertisement while reducing a load of the advertiser for the advertisement production.

### BRIEF DESCRIPTION OF DRAWINGS

FIG. 1 is a configuration environmental diagram of a system for providing a message-based application interlocking lock screen advertisement according to an embodiment of the present invention;

FIGS. 2 and 3 are operational exemplary diagrams for generating advertisement contents in the system for providing the message-based application interlocking lock screen advertisement according to the embodiment of the present invention;

FIG. 4 is an operational exemplary diagram for advertisement display using a lock screen of an advertisement module according to the embodiment of the present invention;

FIG. 5 is an operational exemplary diagram showing an application execution process according to a release of the lock screen of the advertisement module according to the embodiment of the present invention;

FIG. 6 is a detailed configuration diagram of the advertisement module according to the embodiment of the present invention;

FIG. 7 is a detailed configuration diagram of the advertisement service server according to the embodiment of the present invention; and

FIG. 8 is a flowchart of a method of providing a message-based application interlocking lock screen advertisement according to another embodiment of the present invention.

### MODES OF THE INVENTION

Hereinafter, detailed embodiments of the present invention will be described with reference to the drawings.

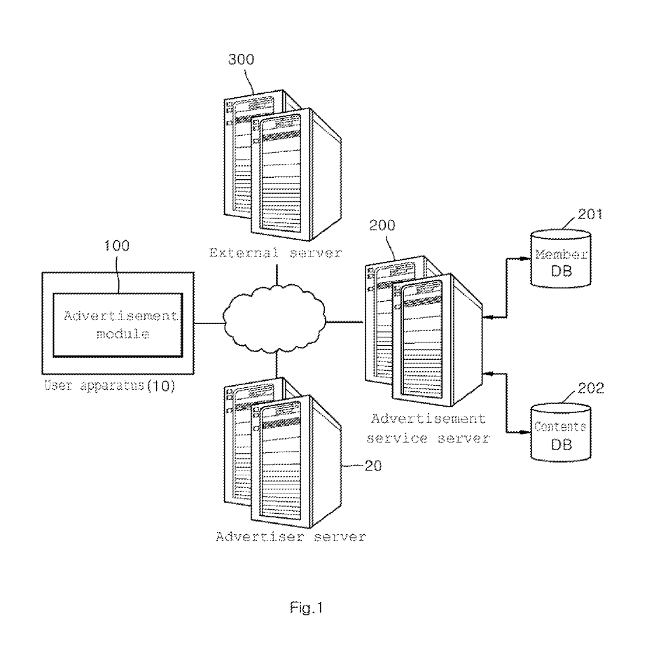

FIG. 1 is a configuration environmental diagram of a system for providing a message-based application interlocking lock screen advertisement according to an embodiment of the present invention. As shown in FIG. 1, the system may include an advertisement module 100 which is configured in a user apparatus 10 to display application-related advertisement contents installed in the user apparatus 10 on a lock screen of the user apparatus 10 and an advertisement service server 200 generating and providing the application-related advertisement contents to be displayed on the lock screen of the user apparatus 10 to the advertisement module 100 of the user apparatus 10 through a communication network.

An advertiser server 20 may provide a push message for an advertisement object related with a specific application via the communication network to the advertisement module 100 of the user apparatus 10.

Accordingly, the advertisement module 100 of the user apparatus 10 may extract at least one of a package ID (alternatively, an application ID) related with the specific application and link information about an execution command related with the advertisement object from the push message and then generate response information including the package ID and the link information to transmit the generated response information to the advertisement service server 200.

As a result, the advertisement service server 200 may access an external server 300 such as an app store server distributing the specific application, generate advertisement contents displayed on the lock screen of the user apparatus 10 according to a predetermined content format in correspondence with the lock screen of the user apparatus 10 based on application information corresponding to the response information, and transmit the generated advertisement contents to the advertisement module 100 of the user apparatus 10 through the communication network.

At this time, the external server 300 may be configured as the advertiser server 20.

Further, the advertisement module 100 adds the content of the push message and the link information to the advertisement contents to display the added content of the advertisement contents on the lock screen of the user apparatus 10 so as to provide the advertisement contents through the lock screen whenever the user apparatus 10 is activated, thereby greatly improving the advertisement efficiency.

At this time, the advertisement contents described in the present invention may be referred to as lock screen contents displayed on the lock screen of the user apparatus.

That is, in a conventional method, the efficiency of the advertisement is low by deleting or ignoring the message without checking due to the inconvenience that the user needs to check the content of the message after activating a separate application at the time of simply transmitting the message for advertisement. However, in the present invention, when the user apparatus 10 receives the push message, after the user apparatus 10 receives the advertisement contents related with the application corresponding to the push message from the advertisement service server 200, the advertisement contents added with the content of the push message and the link information are output on the lock screen of the user apparatus 10 and the advertisement content and the advertisement object related with the specific application may be checked without executing the separate application. As a result, the user may easily check the advertisement content through the lock screen as compared with the existing method in which the advertisement content cannot be checked before the message is browsed, thereby greatly enhancing the advertisement efficiency and the advertisement exposure frequency.

In the above-described configuration, the communication network may be applied with various well-known wired and wireless communication methods, and the advertisement module 100 maybe referred to as an application which is operated based on an operating system executed by a control unit of the user apparatus 10 and installed in the user apparatus 10.

In addition, the advertisement module 100 may be installed in an application installed in the user apparatus and installed at the same time when the application is installed, and may be configured by a software development kit (SDK) which is a type (in application (in-app) included in the application.

Also, the user apparatus 10 may include a smart phone, a mobile communication terminal, and the like, which provide various communication methods.

In addition, in the above-described configuration, the advertisement service server 200 may store the application information, generate advertisement contents based on the prestored application information corresponding to the response information when the advertisement service server 200 receives the response information, and provide the generated advertisement contents to the advertisement module 100 of the user apparatus 10. The external server 300 may be configured by various servers, such as an advertiser server transmitting the push message, an app store server distributing various applications, a game service server providing game applications, or a shopping mall server providing shopping mall-related applications.

In addition, the advertisement service server 200 may include a member DB 201 for storing identification information (alternatively, member information) corresponding to the user apparatus, and a content DB 202 for storing the advertisement contents.

Hereinafter, the detailed configuration of the present invention will be described with reference to the drawings based on the above-described configuration.

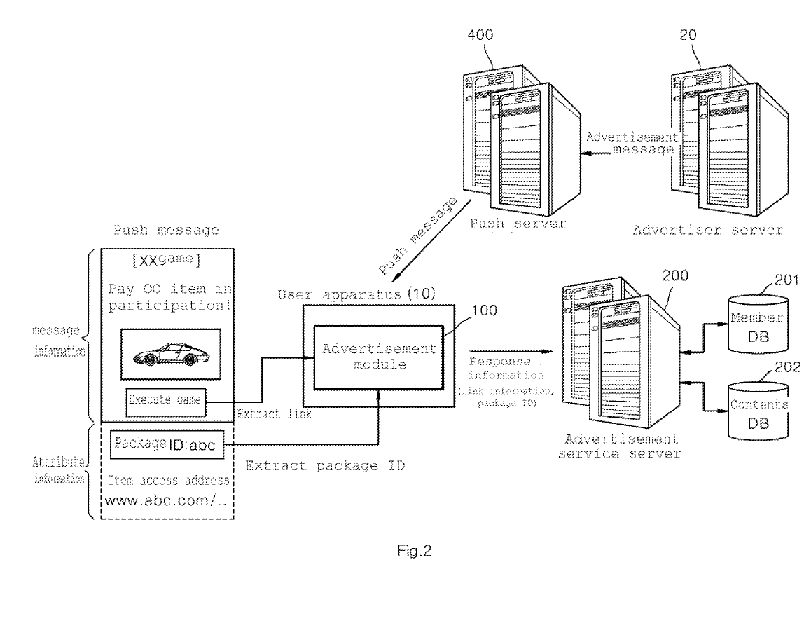

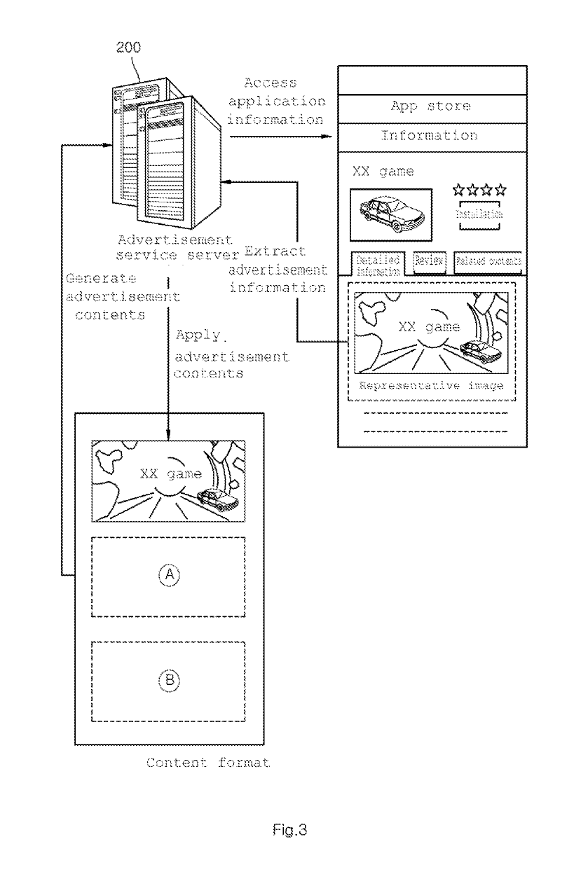

FIGS. 2 and 3 are operational exemplary diagrams for generating advertisement contents in the system for providing the message-based application interlocking lock screen advertisement according to the embodiment of the present invention.

First, as shown in FIG. 2, the advertiser server 20 may identify the user apparatus 10 to which the advertisement message is to be transmitted based on the identification information (alternatively, the member information) of the user apparatus 10 stored in advance, and transmit the advertisement message for the advertisement object corresponding to a specific application as the push message to the user apparatus 10 through the push server 400.

At this time, the push server 400 may be included in the advertiser server 20 and may transmit the push message from the advertiser server 20 to the user apparatus 10.

In addition, the identification information may include at least one of a telephone number, an IP address, media access control (MAC) information and a user's member ID corresponding to the user apparatus 10.

In addition, the advertisement module 100 of the user apparatus 10 may receive the push message through the user apparatus 10, extract at least one of link information about an execution command which is executed in the specific application and related with the advertisement object and a page ID about the specific application included in attribute information of the push message, and then generate response information including at least one of the link information and the package ID to transmit the generated response information to the advertisement service server 200.

Accordingly, as shown in FIG. 3, the advertisement service server 200 may receive the response information from the advertisement module 100 of the user apparatus 10, store the received response information in the external server 300 by accessing the external server 300 providing the specific application based on any one of the link information or the package ID included in the response information, and access the application information corresponding to the link information or the package ID.

In addition, the advertisement service server 200 may collect advertisement information associated with a predetermined content format corresponding to the lock screen of the user apparatus 10, from the application information.

At this time, the advertisement information may mean information corresponding to one or more different attributes preset in the content format, and each attribute may include a data type, metadata, and the like.

In addition, the content format includes set values for a placement area, a size, a font type, and the like for each different metadata, and set values for a placement area, a size, a resolution, and the like of the representative image information according to the data type, and a layout corresponding to the lock screen of the user apparatus 100 may be set.

Accordingly, the advertisement service server 200 may generate the advertisement contents for the lock screen of the user apparatus 10 by applying the advertisement information collected from the application information to the layout according to the content format.

For example, the advertisement service server 200 may extract representative image information associated with the preset content format from the application information as the advertisement information, download the representative image information from the external server 300, and then generate the advertisement contents by adjusting and applying at least one of a size and a resolution to the content format in an arrangement area corresponding to the representative image information according to the layout of the content format.

At this time, the representative image information may include not only image data but also image data or flash data.

Thereafter, the advertisement service server 200 may transmit the advertisement contents to the user apparatus 10 through the communication network, and store the advertisement contents in the contents DB 202.

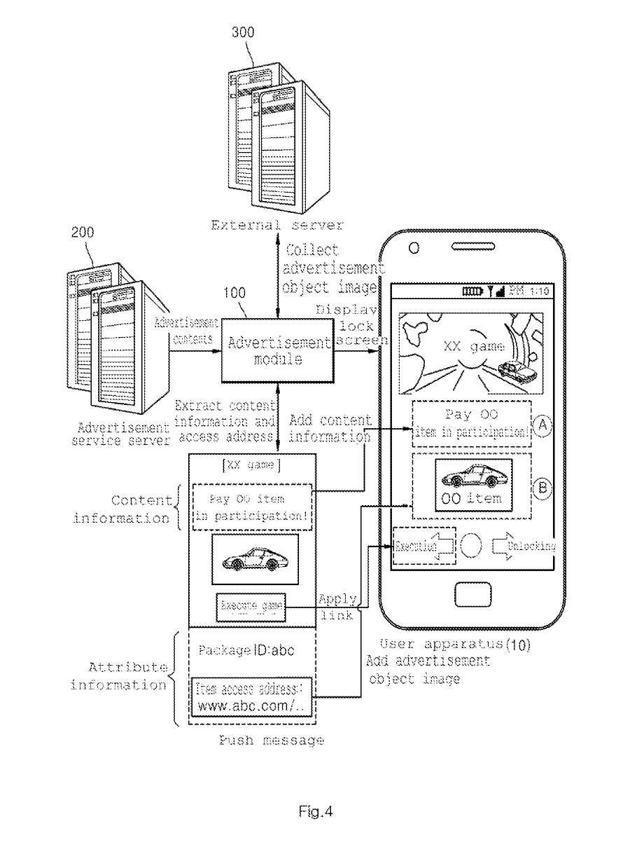

Meanwhile, FIG. 4 is an operational exemplary diagram for advertisement display using the lock screen of the advertisement module 100 receiving the advertisement contents from the advertisement service server 200. As shown in FIG. 4, the advertisement module 100 may receive the advertisement contents from the advertisement service server 200 through the user apparatus 10 in correspondence with the response information.

Thereafter, the advertisement module 100 may extract content information of the push message corresponding to the response information and add the content information to a predetermined area of the advertisement contents.

At this time, the advertisement module 100 may change at least one of a size and a font of a text included in the content information according to preset setting information, and add the changed size or font to the advertisement contents to emphasize content information.

In addition, when there is an access address related to the advertisement object in the attribute field preset in the attribute information of the push message, the advertisement module 100 may extract the access address from the attribute field and access the advertiser server 20 according to the access address.

Accordingly, the advertisement module 100 may collect advertisement object information corresponding to the access address from the advertiser server 20 and add the collected advertisement object information to a predetermined area of the advertisement contents.

In this case, the advertisement object information may be an image for the advertisement object. For example, if the advertisement object is an item applied to a game application, the image for the advertisement object may be an item image.

In addition, the advertisement object information may be coupon information, such as a quick response (QR) code, a bar code, a coupon image or the like for product discounting or payment.

In addition, the advertisement module 100 may add or insert link information of the push message into the advertisement contents.

Thereafter, the advertisement module 100 may display the advertisement contents on the lock screen of the user apparatus 10, and display the advertisement contents on the lock screen displayed whenever the user apparatus 10 is activated.

At this time, when describing the ‘lock screen’ related to the present invention in detail, in order to prevent the user apparatus 10 from being malfunctioned when an input through a touch screen or an external input button continuously occurs regardless of the intention of the user, the locked state is set. Accordingly, the user apparatus 10 displays the lock screen on a display at the time of initial driving of the user apparatus 10 according to the locked state, and unlocks the lock (locked state) only when the predetermined input corresponding to the release of the locked state is received to use a desired function.

In addition, the advertisement module 100 according to the present invention is preferably executed in iOS which is an Apple's mobile operating system, Android which is a Google's mobile operating system, and the like, but the present invention is not limited thereto.

According to the above-described configuration, the advertisement module 100 improves a problem that an advertisement effect is significantly deteriorated because the advertisement message is almost deleted or ignored before the advertisement message is browsed by the user to receive the advertisement contents for the lock screen corresponding to the push message from the advertisement service server 200 and display the advertisement contents on the lock screen of the user apparatus 10. As a result, the user may check the advertisement content and the advertisement object for the specific application through the lock screen whenever the user apparatus 10 is activated, thereby greatly enhancing the advertisement effect.

Meanwhile, in the above-described configuration, the advertisement module 100 of the user apparatus 10 may extract content information included in the push message, and transmit the content information added in the response information to the advertisement service server 200 together with the identification information of the user apparatus 10.

Accordingly, the advertisement service server 200 may generate request information for inquiring and requesting private information related to the user based on the content information and the identification information of the user apparatus 10, and transmit the request information to the advertiser server 20 corresponding to the response information.

At this time, the private information may include various information related to the user, such as information related to a product (e.g., a game item) to be paid to the user, shopping cart information temporarily stored with information of an interest product of the user, or point information of the user.

Also, the advertisement service server 200 may receive private information corresponding to the request information from the advertiser server 20, adds the private information to the advertisement contents, and transmit the advertisement contents to the advertisement module of the user apparatus 10 to display the advertisement contents on the lock screen.

Accordingly, the advertisement service server 200 may collect user-related information based on the content of the push message transmitted from the advertiser server 20, and add the collected user-related information to the advertisement contents to provide the user-related information on the lock screen.

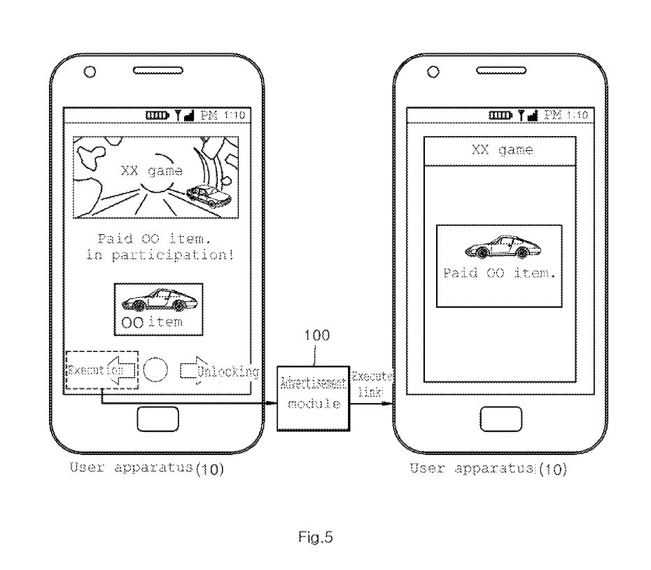

Meanwhile, as shown in FIG. 5, the advertisement module 100 of the user apparatus 10 may display an interface for executing an execution command according to the link information of the push message on the lock screen displayed with the advertisement contents or releasing the lock screen. At this time, the interface may be configured with a graphic user interface (GUI).

Accordingly, when the advertisement module 100 releases the locked state according to the lock screen in a predetermined direction through the user interface displayed on the lock screen based on user input through the user apparatus 10, the advertisement module 100 may execute a specific application corresponding to the advertisement contents according to the link information included (inserted) in the advertisement contents and execute an execution command defined in the link information by the specific application.

For example, the advertisement module 100 may release the lock screen and display an interface fora first input direction for executing the link information included in the advertisement contents and a second input direction for simply releasing the lock screen on the lock screen together with the advertisement contents.

Accordingly, when a swipe, slide, or drag input corresponding to the first input direction is received through the interface based on the user input through the user apparatus 10, the advertisement module 100 may release the lock screen and then execute the specific application installed in the user apparatus 10 and execute the execution command defined in the link information in the specific application to display an execution result according to the execution command on the screen of the user apparatus 10.

For example, the advertisement module 100 may execute the specific application in the same manner as the link information of the push message upon receiving the user input in the first input direction on the lock screen in which the advertisement contents are displayed, and allow an game item to be advertised to be paid based on the execution command according to the link information by the specific application.

In addition, the advertisement module 100 may execute the specific application and register the game item to a game service server that services the specific application in correspondence with the user's membership information.

In addition, the advertisement module 100 may execute the specific application in accordance with the link information to allow the reward to be paid or various execution commands defined in the link information, such as changing the mode of the specific application, to be executed in the specific application.

Meanwhile, the advertisement module 100 may release the locked state according to the lock screen when receiving the user input in the second input direction on the lock screen in which the advertisement contents are displayed and output a predetermined home screen according to an operating system installed in the user apparatus 10 on the screen of the user apparatus 10.

Through the above-described configuration, the advertisement module 100 according to the present invention allows the execution command of the specific application linked to the push message corresponding to the advertisement contents displayed on the lock screen to be automatically executed only by simply inputting the release of the lock screen, thereby improving the convenience of the user and greatly increasing the utilization rate of a specific application by concentrating the user's attention on the advertisement object.

Meanwhile, the advertisement service server 200 may preset different content formats in correspondence with different advertisement messages, respectively. In this way, the advertisement service server 200 may generate an optimal advertisement content applying an optimal content format in correspondence with different advertisement messages to provide the generated optimal advertisement content to the user apparatus 10.

For example, the advertisement service server 200 may receive an advertisement message and selection information about a content format selected by the advertiser from among a plurality of content formats from the advertiser server 20, match the content format selected according to the selection information with the advertisement message, and store the matched content format in the contents DB 202.

Accordingly, the contents DB 202 may store different content formats for generating advertisement contents in correspondence with different advertisement messages of different advertisement objects.

Accordingly, when response information about link information or a package ID related with an advertisement message corresponding to a first application is received from the advertisement module 100 of the user apparatus 10, the advertisement service server 200 may extract a content format A stored in correspondence with the advertisement message included in the response information from the contents DB 202, generate a first advertisement content by applying the advertisement information collected in correspondence with the response information to the content format A, and then transmit the generated first advertisement content to the advertisement module 100 of the user apparatus 10 to display the first advertisement content on the lock screen of the user apparatus 10.

In addition, when response information related with an advertisement message corresponding to a second application different from the first application is received, the advertisement service server 200 may extract a content format B stored in correspondence with the advertisement message included in the response information from the contents DB 202, generate a second advertisement content having a content format different from the content format of the first advertisement content by applying the advertisement information collected in correspondence with the response information to the content format B, and then transmit the generated second advertisement content to the advertisement module 100 of the user apparatus 10 to display the second advertisement content on the lock screen of the user apparatus 10.

Through the above-described configuration, the advertisement service server 200 sets and stores an optimal format capable of enhancing the advertisement efficiency for each different application, generates advertisement contents according to the optimal format, and displays the generated advertisement contents on the lock screen of the user apparatus 10, thereby further enhancing the advertisement efficiency.

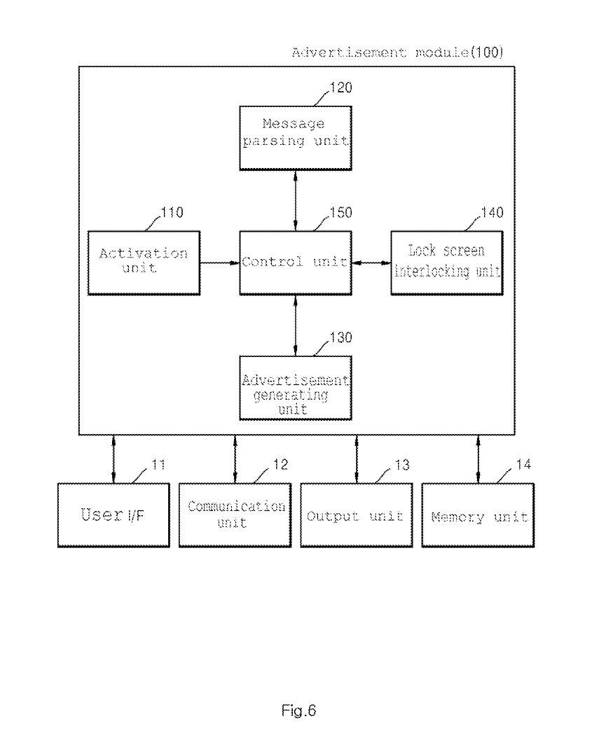

FIG. 6 is a detailed configuration diagram of the advertisement module 100 according to the embodiment of the present invention, and as shown in FIG. 6, the advertisement module 100 may include an activation unit 110, a message managing unit 120, an advertisement generating unit 130, a lock screen interlocking unit 140, and a control unit 150.

The activation unit 110 may receive a user input through the user interface unit 11 configured in the user apparatus 10 and receive selection information about activation or deactivation of the advertisement module 100, and may provide the selection information to the control unit 150.

The control unit 150 may activate each component configured in the advertisement module 100 when the advertisement module 100 is activated according to the selection information and the control unit 150 may provide the push message received through the communication unit 12 configured in the user apparatus 10 to the message managing unit 120.

At this time, the control unit 150 may store the push message in the memory unit 14 configured in the user apparatus 10.

Accordingly, the message management unit 120 may extract at least one of link information and a package ID from the push message, generate response information including at least one of the link information and the package ID, and then provide the response information to the control unit 150.

Also, the control unit 150 may transmit the response information to the advertisement service server 200 through the communication unit 12 of the user apparatus 10.

Meanwhile, the control unit 150 may receive the advertisement contents transmitted from the advertisement service server 200 through the communication unit 12 of the user apparatus 10 and provide the received advertisement contents to the advertisement generating unit 130 together with the push message corresponding to the advertisement contents.

Accordingly, the advertisement generating unit 130 may extract content information of the push message provided from the control unit 150 and add the extracted content information to a predetermined area of the advertisement content. When an access address is present in a predetermined attribute field of the advertisement contents, the advertisement generating unit 130 may collect advertisement object information about the advertisement object by accessing the advertisement object according to the access address and then add the collected advertisement object information to the advertisement contents.

The advertisement generating unit 130 may extract the link information included in the push message to add or insert the extracted link information into the advertisement content and provide the corresponding advertisement contents to the control unit 150.

At this time, the control unit 150 may store the advertisement contents provided from the advertisement generating unit 130 in the memory unit 14.

Thereafter, the control unit 150 provides the advertisement contents provided from the advertisement generating unit 130 to the lock screen interlocking unit 140, and the lock screen interlocking unit 140 may detect the locked state of the user apparatus 10 to output the advertisement contents on the lock screen according to the locked state through the output unit 13 configured in the user apparatus 10.

In the above-described configuration, when a different push message is received in the user apparatus 10, the control unit 150 may display on the lock screen a different advertisement content received in correspondence with the different push message from the advertisement service server 200 by replacing the existing advertisement contents.

The control unit 150 may alternately display a plurality of different advertisement contents stored in the memory unit 14 on the lock screen at predetermined intervals.

Accordingly, the advertisement module 100 may change the advertisement contents displayed on the lock screen at all time whenever a new push message is received to provide various advertisement contents through the lock screen of the user apparatus 10.

Meanwhile, the control unit 150 may display an interface on the lock screen for executing an execution command according to the link information of the push message or releasing the lock screen. When the locked state according to the lock screen is released in a predetermined direction according to the user input through the user interface unit 11, the control unit 150 may execute an application corresponding to the advertisement contents according to the link information included in the advertisement contents, and allow the execution command defined in the link information to be executed by the application.

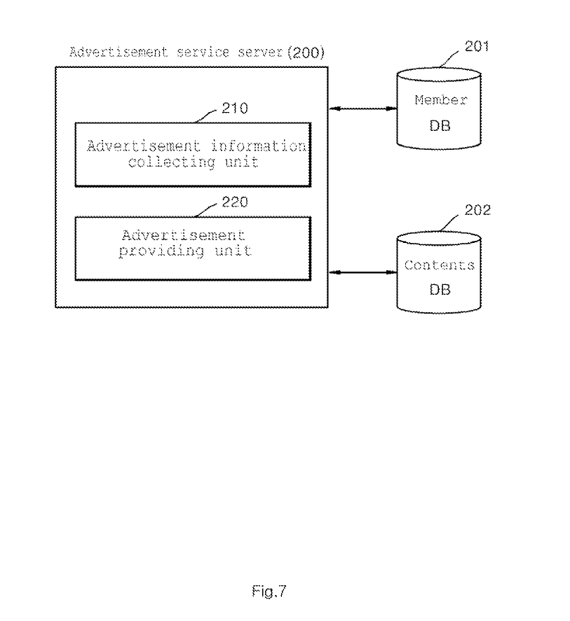

Meanwhile, FIG. 7 is a detailed configuration diagram of the advertisement service server 200 according to the embodiment of the present invention, and as shown in FIG. 7, the advertisement service server 200 may include an advertisement information collecting unit 210 and an advertisement providing unit 220.

The advertisement information collecting unit 210 may access the application information corresponding to the specific application stored in the external server 300 according to the response information received from the user apparatus 10 in correspondence with the push message to collect advertisement information associated with the content format preset in correspondence with the lock screen of the user apparatus 10 from the application information and provide the collected advertisement information to the advertisement providing unit 220.

At this time, the advertisement information collecting unit 210 may store the advertisement information in the contents DB 202.

Meanwhile, the advertisement providing unit 220 may apply advertisement information provided from the advertisement information collecting unit 210 to a predetermined content format to generate advertisement contents displayed on the lock screen of the user apparatus 10 and transmit the generated advertisement contents to the user apparatus 10.

Through the above-described configuration, according to the present invention, the advertisement contents related with the application of the advertiser is automatically generated based on the message provided from the advertiser and the application information stored in the server in correspondence with the advertiser without requesting separate creation of advertisement contents for transmission to the user apparatus to the advertiser for advertising the application to be displayed on the lock screen of the user apparatus, thereby greatly enhancing convenience of advertisement while reducing a load of the advertiser for the advertisement production.

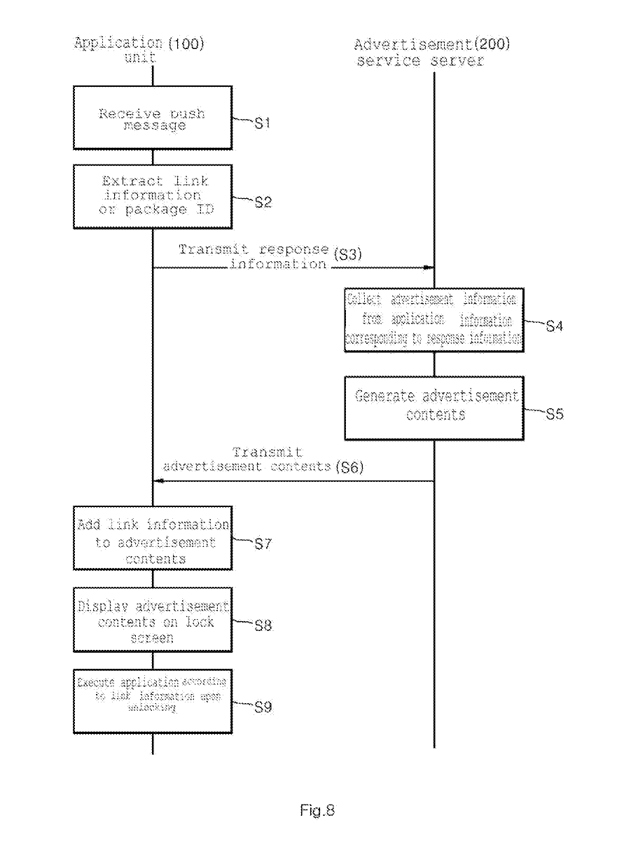

FIG. 8 is a flowchart of a method of providing a message-based application interlocking lock screen advertisement according to another embodiment of the present invention.

As shown in FIG. 8, the advertisement module 100 configured in the user apparatus 10 may receive a push message associated with an application from the advertiser server 20 (S1), extract from the push message at least one of link information and an application-related package ID to generate response information (S2), and transmit the response information to the advertisement service server 200 through a communication network (S3).

Next, the advertisement service server 200 may access the external server 300 providing the application according to the response information, and collect advertisement information associated with a predetermined content format from the application information corresponding to the link information or the package ID included in the response information in correspondence with the lock screen according to the locked state of the user apparatus 10 (S4).

Thereafter, the advertisement service server 200 may generate advertisement contents by applying the advertisement information to the content format (S5), and transmit the advertisement contents to the advertisement module 100 of the user apparatus 10 (S6).

Next, the advertisement module 100 may add link information of the push message to the advertisement contents received from the advertisement service server 200 through the user apparatus 10 (S7) and display the added link information on the lock screen of the user apparatus 10 (S8).

Thereafter, the advertisement module 100 executes the application in accordance with the link information when the locked state according to the lock screen is released in a predetermined direction according to the user input through the user apparatus 10 so that an execution command according to the link information is executed through the application (S9).

Various apparatuses and components described in the present specification may be embodied by a hardware circuit (for example, a CMOS based logic circuit), firmware, software, or combinations thereof. For example, the apparatuses and components maybe embodied by using a transistor, a logic gate, and an electronic circuit in the forms of various electric structures.

Further, each component (alternatively, each module) of the user apparatus may be software stored in the memory of the user apparatus. The memory may be an internal memory of the user apparatus and may an external memory or other types of storage devices. Further, the memory may be a nonvolatile memory. The software stored on the memory may include a command set to allow the user apparatus to perform a specific operation while executing.

As described above, it will be understood to those skilled in the art that the present invention can be corrected and modified without departing from the intrinsic features of the present invention. Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

What is claimed is:

1. A system for providing a message-based application interlocking lock screen advertisement including a user apparatus and an advertisement service server connected to the user apparatus through a communication network, the system comprising:
an advertisement module installed in the user apparatus configured to
parse a push message received from the user apparatus,
extract at least one of link information and a package ID related with application included in the push message,
generate a response information,
transmit the generated response information to the advertisement service server, and
display lock screen contents received from the advertisement service server in correspondence with the response information; and
the advertisement service server configured to
access an external server providing the application according to the response information received from the user apparatus,
collect advertisement information associated with a predetermined content format in correspondence with the lock screen according to a locked state of the user apparatus from application information corresponding to the link information or the package ID included in the response information,
generate the lock screen contents by applying the advertisement information to the content format, and
transmit the lock screen contents to the advertisement module of the user apparatus.

2. The system of claim 1, wherein the advertisement information is a representative image included in the application information.

3. The system of claim 1, wherein the advertisement module is configured to
add content information included in the push message to the lock screen contents, and
display the content information on the lock screen.

4. The system of claim 3, wherein the advertisement module is configured to
change at least one of a size and a font of a text included in the content information according to preset setting information to add the changed size or font to the lock screen contents, or
collect, when an access address is included in a predetermined field in attribute information of the push message, advertisement object information corresponding to the access address after accessing the access address to add the collected advertisement object information to the lock screen contents.

5. The system of claim 4, wherein the advertisement object information is coupon information including a QR code, a barcode, or a coupon or an image for the advertisement object.

6. The system of claim 3, wherein the advertisement module is configured to transmit the content information included in the push message and identification information of the user apparatus to the advertisement service server, and
the advertisement service server is configured to
transmit request information for requesting user-related private information corresponding to the content information and the identification information to an advertiser server which transmits the push message to the user apparatus, and
add the private information received from the advertiser server to the lock screen contents.

7. The system of claim 6, wherein the private information includes at least one of information related to a product to be provided to the user, shopping cart information of the user, and point information of the user.

8. The system of claim 1, wherein the advertisement module is configured to
add the link information of the push message to the lock screen contents to display the added link information on the lock screen of the user apparatus, and
execute, when the locked state according to the lock screen is released in a predetermined direction according to the user input through the user apparatus, the application according to the link information.

9. The system of claim 8, wherein the advertisement module is configured to, according to the link information,
execute the application to allow a reward to be paid or
change a mode of the application.

10. The system of claim 1, wherein the advertisement service server is configured to
preset a plurality of different content formats, and
apply the advertisement information to the content format corresponding to the response information received from the user apparatus to generate the lock screen contents.

11. The system of claim 1, wherein the advertisement module is configured by an SDK inserted to the application installed in the user apparatus.

12. A method for providing a message-based application interlocking lock screen advertisement comprising:
a response step of receiving, by an advertisement module installed in an user apparatus, a push message related with an application, extracting at least one of link information and a package ID related with application from the push message to generate response information, and transmitting the response information to an advertisement service server through a communication network;
a content generation step of accessing, by the advertisement service server, an external server providing the application according to the response information to collect advertisement information associated with a predetermined content format in correspondence with the lock screen according to the locked state of the user apparatus from application information corresponding to the response information, and generating lock screen contents by applying the advertisement information to the content format;
a transmission step of transmitting, by the advertisement service server, the lock screen contents to the advertisement module of the user apparatus; and
a display step of adding, by the advertisement module, link information of the push message to the generated lock screen contents and displaying the lock screen contents on the lock screen of the user apparatus.

13. The method of claim 12, wherein the advertisement information is a representative image included in the application information.

14. The method of claim 12, wherein in the display step, the advertisement module adds content information included in the push message to the lock screen contents and displays the content information on the lock screen.

15. The method of claim 14, wherein in the display step, according to preset setting information, the advertisement module changes a size and a font of a text included in the content information to add the changed size or font to the lock screen contents, or collects, when an access address is included in a predetermined field in attribute information of the push message, advertisement object information corresponding to the access address after accessing the access address to add the collected advertisement object information to the lock screen contents.

16. The method of claim 15, wherein the advertisement object information is coupon information including a QR code, a barcode, or a coupon or an image for the advertisement object.

17. The method of claim 12, further comprising:
after the display step, an execution step of executing, by the advertisement module, when the locked state according to the lock screen is released in a predetermined direction according to the user input through the user apparatus, the application according to the link information.

18. The method of claim 17, wherein in the execution step, according to the link information, the advertisement module executes the application to allow a reward to be paid or changes a mode of the application.

19. The method of claim 12, wherein in content generation step, the advertisement service server, in which a plurality of different content formats is preset, applies the advertisement information to the content format corresponding to the response information received from the user apparatus to generate the lock screen contents.

20. The method of claim 12, wherein the advertisement module is configured by an SDK inserted to the application installed in the user apparatus.
